(19) United States
(12) Patent Application Publication
(10) Pub. No.: US 2009/0117940 A1
(43) Pub. Date: May 7, 2009

(54) Electronic device with biological characteristics activation of execution command

(75) Inventor: Kuo-Tai Hsu, Taipei (TW)

Correspondence Address: BIRCH STEWART KOLASCH & BIRCH, PO BOX 747, FALLS CHURCH, VA, 22040-0747, US

(73) Assignees: GIGA-BYTE COMMUNICATIONS INC.; GIGA-BYTE TECHNOLOGY CO., LTD.

(21) Appl. No.: 12/155,428

(22) Filed: Jun. 4, 2008

(30) Foreign Application Priority Data
Nov. 6, 2007 (TW) 096141939

(51) Int. Cl. H04M 1/00

(52) U.S. Cl. 455/556.1

(57) ABSTRACT

An electronic device is provided to allow users to input a biological characteristic and self-define an execution command corresponding to the biological characteristic. The electronic device includes a key unit, a biological characteristic input unit, a storage unit and a processing unit. A biological characteristic can be inputted to the biological characteristic unit. At least a set of the biological characteristic data can be built by activating a biological characteristic configuration program via the processing unit to execute command to the storage unit.

### CROSS-REFERENCE TO RELATED APPLICATIONS

This nonprovisional application claims priority under 35 U.S.C. §119(a) on Patent Application No. 096141939, filed in Taiwan on Nov. 6, 2007, the entirety of which is incorporated herein by reference.

### BACKGROUND OF THE INVENTION

1. Field of the Invention

The present invention generally relates to finger-print recognition technology and hotkeys of an electronic device, and more particular to an electronic device with biological characteristics activation of execution command.

2. Background of the Invention

An intelligent mobile phone with a shortcut menu is disclosed in Taiwanese Patent Application Publication No. 200723829. Users can set the functions of the shortcuts in the menu, add common used functions to the menu, and/or remove the rarely used functions out of the menu. The shortcut menu includes a plurality of function options and the corresponding execution paths.

A quick custom configuration system of a small mobile data processor is disclosed in Taiwanese Patent Application Publication No. 200726187. A user can modify built-in shortcut operation methods in a mobile phone, and set up the required shortcuts and the corresponding services.

A mobile phone with a one-key internet connection device is disclosed in Taiwanese Patent No. M255594. The shortcut key is configured by the users based on their habits. The operation procedure is recorded as the function key for a quick internet connection.

The above-mentioned devices lack for security and whoever holds the devices can operate them and access the data inside the devices.

Fingerprint recognition technology used in mobile communication devices such as mobile phones and PDAs are disclosed in Taiwanese Patent Nos. I267791, I270013, and Taiwanese Patent Application Publication No. 200611539. With the function of finger-print recognition, the devices can only be accessed by users who can pass the fingerprint verification. The function of finger-print recognition here is only used for identification, not for activating any function of the mobile phone.

An appliance with its function driven by fingerprint recognition is disclosed in Taiwanese Patent No. I225620. The appliance is connected to a computer. A “fingerprint-shortcut” look-up table needs to be pre-defined and stored into an internal or external storage device of the appliance. The rule is one finger-print for one function, for example, finger-print of the right pinkie for print function, and the left pinkie for power off. Therefore, users can activate different functions of the computer with different finger-prints. The problem is that the functions in the table cannot be added or removed; moreover, users can input finger-prints according to the functions only, instead of choosing functions according to the finger-prints.

### SUMMARY OF THE INVENTION

It is an object of the present invention to provide an electronic device, especially a mobile communication device, which allows a user to input a biological characteristic and self-define an execution command corresponding to the biological characteristic.

The electronic device according to the present invention comprises a key unit, a biological characteristic input unit, a storage unit, and a processing unit. The biological characteristic input unit can receive a biological characteristic and digitalize it to produce a biological characteristic data accordingly. The storage unit stores a biological characteristic configuration program and a biological characteristic activation program that can be executed by the processing unit.

The biological characteristic configuration program comprises the steps of: receiving the biological characteristic data, receiving a serial of signals that a user inputs to realize certain target function such as making a call, generating an execute command and storing the execute command and the corresponding biological characteristic data to the storage unit in pairs. The biological characteristic activation program includes the steps of: receiving the biological characteristic data from the biological characteristic input unit, finding out the corresponding biological characteristic data and execute command, and realizing the target function according to the execute command, such as delivering a request for calling to a corresponding communication device.

Compared to the prior art, the execute command is generated according to the signal inputted by users to realize a target function. With the present invention, users can customize the execute command according to the biological characteristic inputted, thereby activating a function by the biological characteristic.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a block diagram in accordance with an embodiment of the present invention;

FIG. 2 is a flow chart of the biological characteristic configuration program in accordance with an embodiment of the present invention; and

FIG. 3 is a flow chart of the biological characteristic activation program in accordance with an embodiment of the present invention.

### DETAILED DESCRIPTION OF THE ILLUSTRATED EMBODIMENTS

The present invention will now be described in detail with reference to the accompanying drawings, wherein the same reference numerals will be used to identify the same or similar elements throughout the several views. It should be noted that the drawings should be viewed in the direction of orientation of the reference numerals.

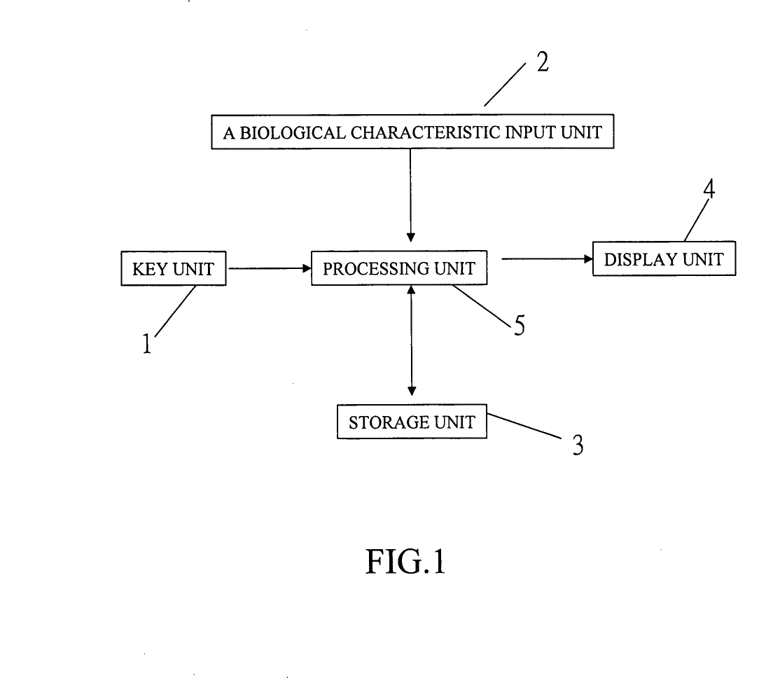

FIG. 1 is a block diagram in accordance with an embodiment of the present invention. A communication device comprises a key unit 1, a biological characteristic input unit 2, a storage unit 3, a display unit 4, and a processing unit 5.

The key unit 1 includes a plurality of keys. Once a key is pressed, a corresponding input signal will be generated and transferred to the processing unit 5. The key unit 1 can be an independent keyboard or a visual keyboard on a touch screen.

The biological characteristic input unit 2 receives a biological characteristic and digitalizes the biological characteristic to generate the corresponding biological characteristic data. The biological characteristic input unit 2 can be a finger-print input device, an iris input device or any other biological characteristic input devices, among which the finger-print inputting device is preferred.

The storage unit 3, which is used for storing programs, commands, and data, usually includes one or more ROMs or flash memories.

The display unit 4 can be an ordinary LCD module, or a touch screen mentioned above.

The processing unit 5 is respectively connected to each of the units mentioned above. As the core of the communication device, it usually comprises a central processor, a RAM, and other circuits such as a RF communicating module. The processing unit 5 controls communicating and other accessory functions such as mobile internet service, short message service, multimedia message service, phone configuration, contacts, etc. If the communication device is a PDA, the processing unit 5 further controls other functions related to the PDA.

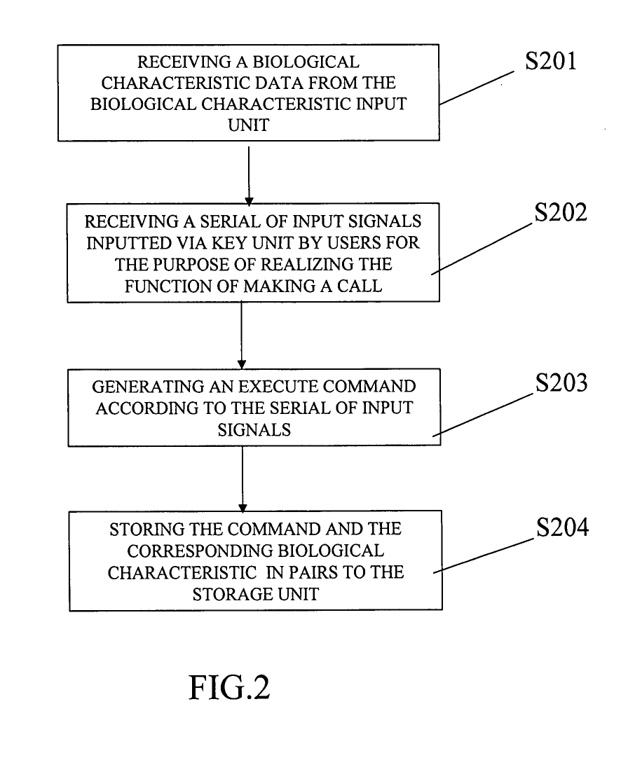

The storage unit 3 stores a biological characteristic configuration program and a biological characteristic activation program for the processing unit 5 to execute. The processing unit 5 starts to execute the biological characteristic configuration program when receiving a specific signal, which may be generated by a selective keystroke or pressing a key for a preset time. As shown in FIG. 2, the biological characteristic configuration program comprises the steps of:

a) receiving a biological characteristic data from the biological characteristic input unit 2, for example, a finger-print data;

b) receiving a serial of signals inputted through the key unit 1 by users to realize a communication function, wherein when a numerical key is pressed, the signal represents a number, and when a function key is pressed, the signal represents a command for executing the function such as activating the phone configuration menu;

c) generating an execute command according to the serial of input signals, wherein the execute command includes a phone number inputted by users; and

d) storing the execute command and the corresponding biological characteristic data to the storage unit 3 in pairs.

When the users expect that the biological characteristic in step a) is associated with the function of making a call to somebody automatically, a serial of signals of instructions and data are input via the key unit 1. No matter how many input signals there are, all of the signals in step b) and c) will be recorded and converted into an execute command including the telephone number of that particular person or the path pointing to the data of the telephone number. The telephone number can be a mobile telephone number or a home phone number. Therefore, the execute command actually corresponds to a communication device of that particular person. When the command is executed, it means that the mobile communication device delivers a request for calling, or makes a call, to the communication device of that particular person. Therefore, the communication function in step b) is realized.

The execute command and the biological characteristic in storage unit 3 are matched in pairs. That is, one biological characteristic data only matches to one execute command. For example, the biological characteristic data of the thumb finger-print match to the first execute command, while the biological characteristic data of the middle finger-print match to the second execute command. All of the data can be stored in a database or a data array. Through the biological characteristic configuration program, users can store a plurality of finger-print data in the storage unit 3, and set a dial number or a function for each finger-print.

After the above configuration, the storage unit 3 stores a set of pairs of “biological characteristic-execute command”, or a look-up table, for the biological characteristic activation program.

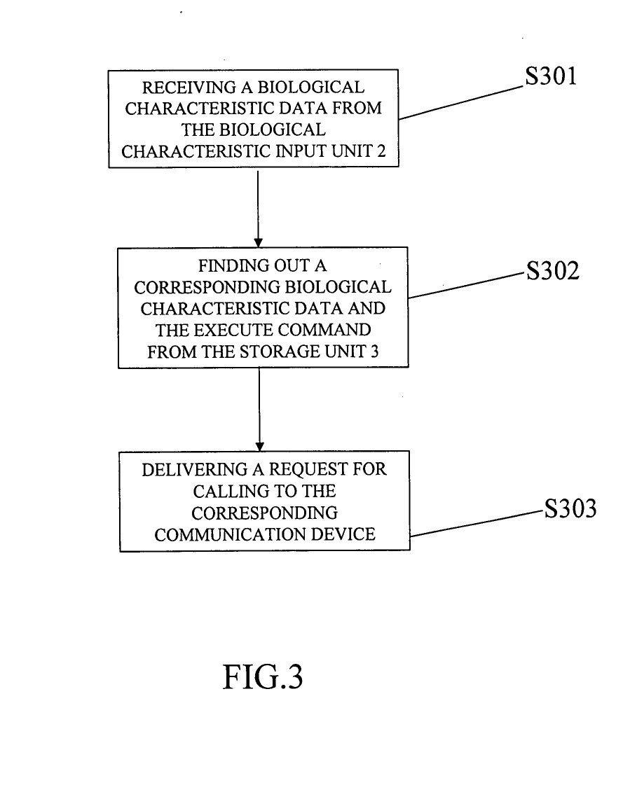

When users want to call somebody, they only need to remember the biological characteristic corresponding to that particular person, and input the biological characteristic through the biological characteristic input unit 2, for example, a finger-print scanning device. Then, the processing unit 5 executes the biological characteristic activation program, to send a request for calling to the communication device of that particular person. As shown in FIG. 3, the biological characteristic activation program comprises the steps of:

a) receiving a biological characteristic data from the biological characteristic input unit 2;

b) finding out a corresponding biological characteristic data and the corresponding execute command from the storage unit 3; and

c) delivering a request for calling to the corresponding communication device.

The processing unit 5 can compare the biological characteristic data from the biological characteristic input unit 2 with all of the biological characteristic data in the database, to find out a corresponding execute command to be executed. Therefore, the function, such as the communicating function and mobile internet service, can be realized.

The present invention allows a user to realize his target function by activating execute command according to the biological characteristic. The present invention provides security, safety and convenience. More important, a user can self-define a corresponding execute command according to the inputted biological characteristic, in a simple and quick way.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A mobile communication device, comprising:
a key unit for generating a corresponding input signal according to a user's keystroke;
a biological characteristic input unit for receiving a biological characteristic and digitalizing the biological characteristic to produce a biological characteristic data accordingly;
a storage unit for storing a biological characteristic configuration program and a biological characteristic activation program; and
a processing unit for executing the biological characteristic configuration program and the biological characteristic activation program, and starting to execute the biological characteristic configuration program only when receiving a specific signal from the key unit.

2. The mobile communication device of claim 1, wherein the biological characteristic configuration program, embodied in the storage unit and readable by the processing unit, comprises:
computer executable code configured to receive the biological characteristic data from the biological characteristic input unit;
computer executable code configured to receive a serial of input signals inputted via the key unit by the user for realizing a function of making a call;
computer executable code configured to generate an execute command according to the serial of input signals; and
computer executable code configured to store the execute command and the corresponding biological characteristic data in pairs to the storage unit.

3. The mobile communication device of claim 1, wherein the biological characteristic activation program, embodied in the storage unit and readable by the processing unit, comprises:
computer executable code configured to receive the biological characteristic data from the biological characteristic input unit;
computer executable code configured to find out the biological characteristic data and a corresponding execute command from the storage unit; and
computer executable code configured to deliver a request for calling to the mobile communication device.

4. An electronic device, comprising:
a key unit for generating a corresponding input signal according to a user's keystroke;
a biological characteristic input unit for receiving a biological characteristic and digitalizing the biological characteristic to produce a biological characteristic data accordingly;
a storage unit for storing a biological characteristic configuration program and a biological characteristic activation program; and
a processing unit for executing the biological characteristic configuration program and the biological characteristic activation program, and starting to execute the biological characteristic configuration program only when receiving a specific signal from the key unit.

5. The electronic device of claim 4, wherein, the biological characteristic configuration program, embodied in the storage unit and readable by the processing unit, comprises:
computer executable code configured to receive the biological characteristic data from the biological characteristic input unit;
computer executable code configured to receive a serial of input signals inputted via key unit by the user for realizing a function of making a call;
computer executable code configured to generate an execute command according to the serial of input signals; and
computer executable code configured to store the execute command and the corresponding biological characteristic data in pairs to the storage unit.

6. The electronic device of claim 4, wherein the biological characteristic activation program, embodied in the storage unit and readable by the processing unit, comprises:
computer executable code configured to receive the biological characteristic data from the biological characteristic input unit;
computer executable code configured to find out the biological characteristic data and a corresponding execute command from the storage unit;
computer executable code configured to execute the corresponding execute command to realize a target function.
